(19) United States
(12) Patent Application Publication
(10) Pub. No.: US 2017/0364585 A1
(43) Pub. Date: Dec. 21, 2017

(54) SEARCH SERVICE PROVIDING DEVICE, METHOD, AND COMPUTER PROGRAM

(71) Applicant: NAVER Corporation, Seongnam-si (KR)

(72) Inventors: Chun Sik GANG, Seongnam-si (KR); Do Youn KIM, Seongnam-si (KR)

(73) Assignee: NAVER Corporation, Seongnam-si (KR)

(21) Appl. No.: 15/696,288

(22) Filed: Sep. 6, 2017

Related U.S. Application Data
(63) Continuation of application No. PCT/KR2016/004037, filed on Apr. 19, 2016.

(30) Foreign Application Priority Data
Jun. 15, 2015 (KR) 10-2015-0084329

(51) Int. Cl. G06F 17/30

(52) U.S. Cl. CPC G06F 17/30684; G06F 17/30687

(57) ABSTRACT

Provided is a search service providing method of providing search results related to a search word performed by a search service providing device, the search service providing method comprising: receiving, by the search service providing device, an initial search word; determining, by the search service providing device, one or more additional search words based on the initial search word; ranking, by the search service providing device, the one or more additional search words; selecting, by the search service providing device, at least one related search word from among the one or more additional search words based on the ranking; and providing, by the search service providing device, additional search results corresponding to the at least one related search word, the initial search word, an initial search result corresponding to the initial search word, and the one or more additional search words.

### CROSS-REFERENCE TO RELATED APPLICATIONS

This application is a continuation of, and claims priority under 35 U.S.C. §365(c) from, PCT International Application No. PCT/KR2016/004037 which has an International filing date of Apr. 19, 2016, which designates the United States of America, and which claims priority to Korean Patent Application No. 10-2015-0084329 filed on Jun. 15, 2015, the contents of both of which are hereby incorporated by reference in their entireties.

### TECHNICAL FIELD

Some example embodiments relate to a search service providing device, method, and non-transitory computer readable medium storing a computer program.

### BACKGROUND

With the development of information and communication technology and technology related to electronic apparatuses, various types of information are acquired via a method of accessing a portal site or using a search application by using an electronic apparatus, such as a desktop computer, a laptop computer, or a smart phone connected to a communication network, such as the Internet.

However, since a vast amount of data exists in the communication network, such as the Internet, a user using an information search function may have to do several searches a number of times to obtain particular desired information.

In addition, since it is generally difficult for the user using the information search function to have all relevant knowledge about various professional fields, the user may not accurately know which question may solve his/her problem or satisfy his/her curiosity.

Information disclosed in this Background section may contain information that does not form the prior art that is already known to the public.

Provided are a search service providing device, method, and non-transitory computer readable medium storing a computer program, which determine one or more additional search words from an initial search word received from a user and provide additional search results for the additional search words together with an initial search result for the initial search word.

Provided are a search service providing device, method and non-transitory computer readable medium storing a computer program, which determine rankings of additional search words and provide an additional search result for at least one additional search word together with an initial search result for an initial search word in consideration of the determined rankings.

Provided are a search service providing device, method, and non-transitory computer readable medium storing a computer program, which determine additional search words capable of providing a useful search result to a user from an initial search word received from the user.

### SUMMARY

According to some example embodiments, a search service providing method of providing search results related to a search word performed by a search service providing device. The search service providing method includes receiving, by the search service providing device, an initial search word. The search service providing method further includes determining, by the search service providing device, one or more additional search words based on the initial search word. The search service providing method further includes ranking, by the search service providing device, the one or more additional search words. The search service providing method further includes selecting, by the search service providing device, at least one related search word from among the one or more additional search words based on the ranking. Furthermore, the search service providing method includes providing, by the search service providing device, additional search results corresponding to the at least one related search word, the initial search word, an initial search result corresponding to the initial search word, and the one or more additional search words.

Such an aspect may be executed by using a system, method, non-transitory computer readable medium storing a computer program, or a combination of the system, method, and non-transitory computer readable medium storing a computer program.

According to some example embodiments, a search service providing device providing search results related to a search word, the search service providing device includes: an input receiver configured to receive an initial search word. The search service providing device also includes a controller configured to determine one or more additional search words based on the initial search word, determine rankings of the one or more additional search words, select at least one related search word from among the one or more additional search words based on the rankings, and provide additional search results corresponding to the at least one related search word, the initial search word, an initial search result corresponding to the initial search word, and the one or more additional search words.

These and/or other aspects will become apparent and more readily appreciated from the following description of some example embodiments, taken in conjunction with the accompanying drawings.

According to some example embodiments, a search service providing device, method, and non-transitory computer readable medium storing a computer program, which determine one or more additional search words from an initial search word received from a user and provide additional search results for the additional search words together with an initial search result for the initial search word, may be provided.

Also, a search service providing device, method and non-transitory computer readable medium storing a computer program, which determine rankings of additional search words and provide an additional search result for at least one additional search word together with an initial search result for an initial search word in consideration of the determined rankings, may be provided

Also, a search service providing device, method, and non-transitory computer readable medium storing a computer program, which determine additional search words capable of providing a useful search result to a user from an initial search word received from the user, may be provided.

### DESCRIPTION OF THE DRAWINGS

FIG. 1 is a schematic diagram of a structure of a search service providing system according to some example embodiments.

FIG. 2 is a schematic diagram of a structure of a search service providing system contained with a user terminal according to some example embodiments.

FIG. 3 is a schematic block diagram of an internal structure of the search service providing system of FIG. 1.

FIGS. 4, 5A and 5B (hereinafter FIGS. 5A and 5B are referred to collectively as FIG. 5) are schematic diagrams of examples of search data being provided by a search service providing device, according to some example embodiments.

FIG. 6 is a flowchart of a search service providing method according to some example embodiments.

### DETAILED DESCRIPTION

Reference will now be made in detail to some example embodiments, examples of which are illustrated in the accompanying drawings. In this regard, some example embodiments may have different forms and should not be construed as being limited to the descriptions set forth herein. Accordingly, some example embodiments are merely described below, by referring to the figures, to explain aspects of some example embodiments. While such terms as “first”, “second”, etc., may be used to describe various components, such components must not be limited to the above terms. The above terms are used only to distinguish one component from another. An expression used in the singular encompasses the expression of the plural, unless it has a clearly different meaning in the context. In the present specification, it is to be understood that terms such as “including” or “having,” etc., are intended to indicate the existence of features or components, and are not intended to preclude the possibility that one or more other features or components may exist or may be added. In the drawings, for convenience of description, sizes of components may be exaggerated for clarity. For example, since sizes and thicknesses of components in drawings are arbitrarily shown for convenience of description, the sizes and thicknesses are not limited thereto.

Hereinafter, some example embodiments will be described below in more detail with reference to the accompanying drawings. Those components that are the same or are in correspondence are rendered the same reference numeral regardless of the figure number, and redundant explanations are omitted.

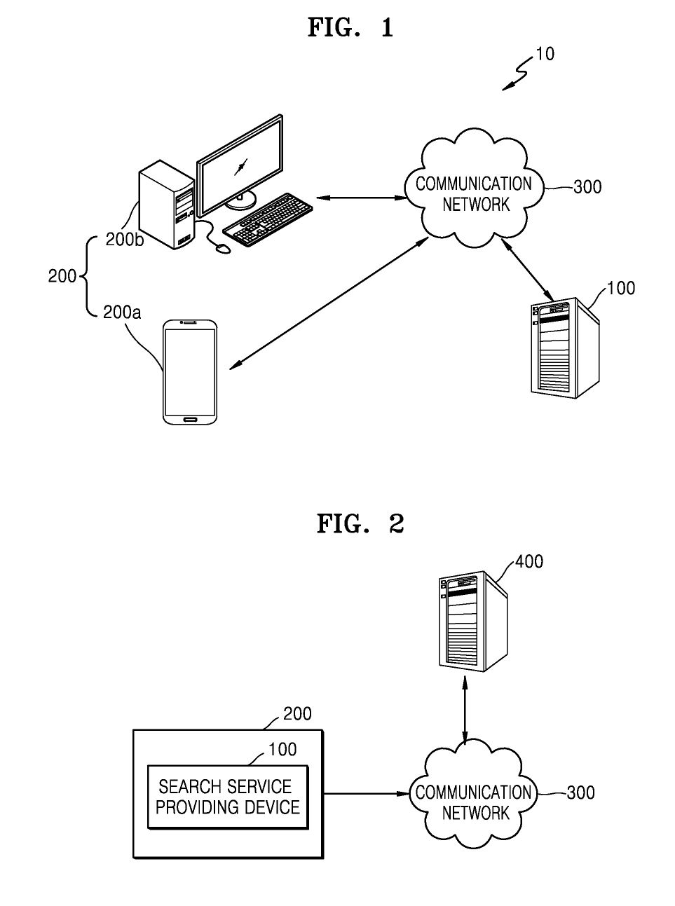

FIG. 1 is a schematic diagram of a structure of a search service providing system according to some example embodiments.

Referring to FIG. 1, a search service providing system 10 according to some example embodiments may include a search service providing device 100, a user terminal 200, and a communication network 300.

The search service providing device 100 may be a device receiving a search word from a user and providing a search result to the user. In detail, the search service providing device 100 may be a device that receives an initial search word from the user terminal 200 through the communication network 300, and provides an initial search result for the initial search word to the user terminal 200. Here, the search service providing device 100 may be a server that stores a massive amount of information that may be provided as search results. In this case, although one search service providing device 100 is shown in FIG. 1, a plurality of devices may exist and be connected in a wired/wireless communication manner according to traffic or an amount of information.

In some example embodiments, information may denote data, such as a text message, a drawing, a photograph, a video, an electronic document, or an electronic signal, which is exchangeable between electronic devices via electricity, radio waves, or other different other electronic materials or physical quantities, in a wired/wireless communication environment.

The search service providing device 100 according to some example embodiments may provide a useful and wide range of information to the user by determining one or more additional search words based on the initial search word received from the user, determining rankings of the one or more additional search words based on a certain criterion, and providing, together with the initial search result, additional search results corresponding to a certain number of higher ranked additional search words.

The search service providing device 100 may be a portal service providing server providing various services accommodating user convenience, in addition to a general search service. In other words, the search service providing device 100 may be a server providing various services, such as a portal service including a search service, an email service, a blog service, a social network service (SNS), a news service, and a shopping information providing service.

Alternatively, the search service providing device 100 may be a physical device connected to a service providing server providing various services, in a wired/wireless communication manner.

The user terminal 200 may be a communication terminal capable of using a web service in a wired/wireless communication environment. In FIG. 1, as examples of the user terminal 200, a first user terminal 200a in a form of a smart phone and a second user terminal 200b in a form of a desktop computer are illustrated. However, some example embodiments are not limited thereto, and any electronic device capable of exchanging data with another device in a wired/wireless communication environment may be unlimitedly used as the user terminal 200.

In further detail, examples of the user terminal 200 include a tablet personal computer (PC), a smart television (TV), a mobile phone, a personal digital assistant (PDA), a laptop computer, a media player, a micro-server, a global positioning system (GPS) device, an electronic book terminal, a digital broadcasting terminal, a navigation device, a kiosk, an MP3 player, a digital camera, a wearable device, and other mobile or non-mobile computing devices, but are not limited thereto.

The communication network 300 may connect the search service providing device 100 and the user terminal 200 to each other. In other words, the communication network 300 may denote a communication network that provides an access path such that the user terminal 200 and the search service providing device 100 may exchange data. Examples of the communication network 300 may include wired networks, such as a local area network (LAN), a wide area network (WAN), a metropolitan area network (MAN), and an integrated service digital network (ISDN), and wireless networks, such as a wireless LAN, a code division multiple access (CDMA), Bluetooth, and a satellite communication network, but are not limited thereto.

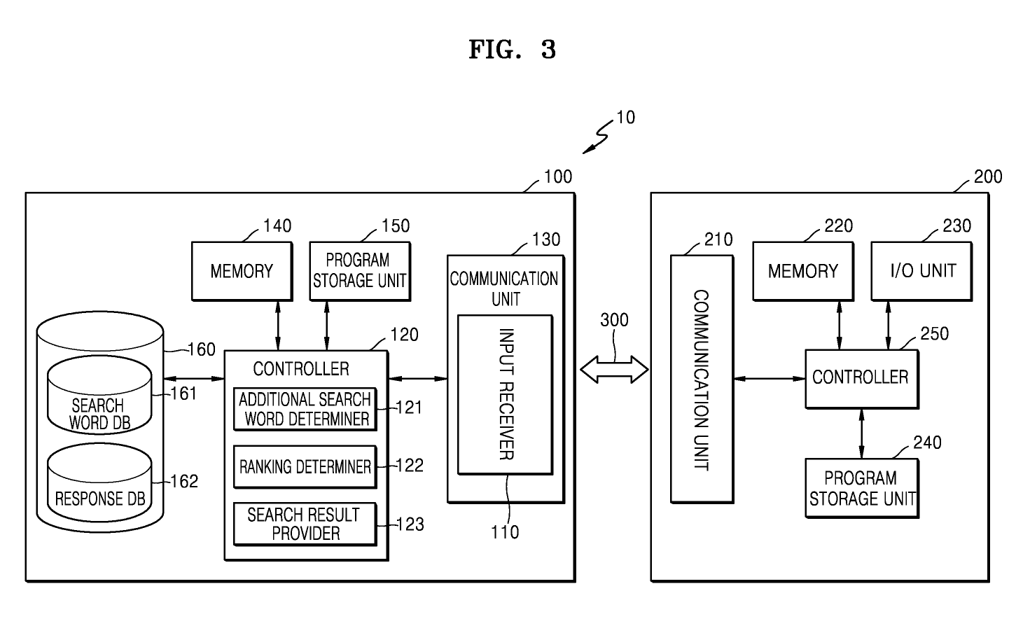

FIG. 2 is a schematic diagram of a structure of a search service providing system according to some example embodiments.

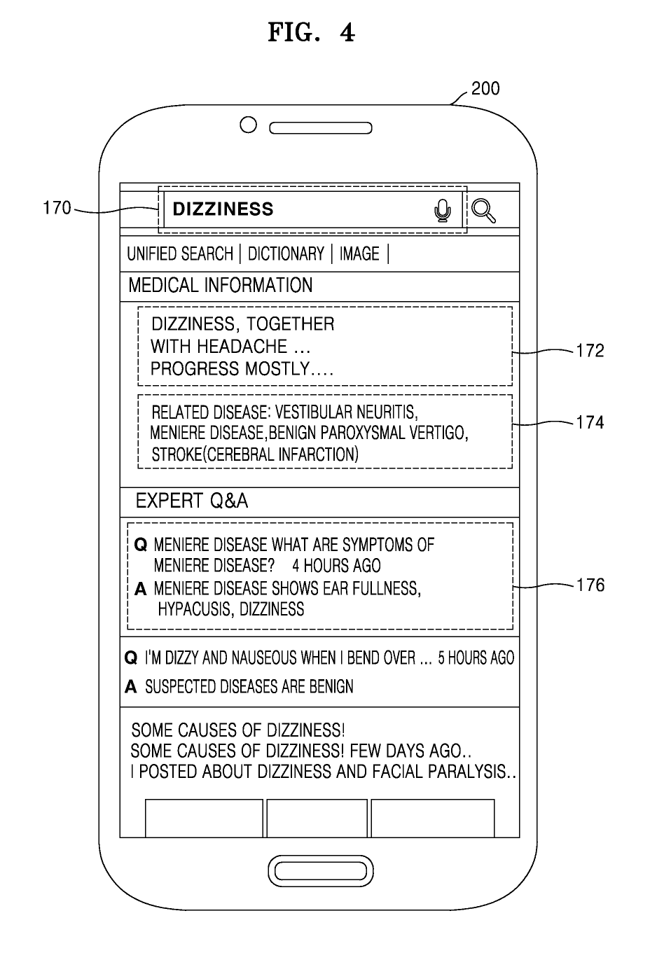

Referring to FIGS. 2 and 3, the search service providing device 100 may be a device included in the user terminal 200. In other words, the search service providing device 100 may not be hardware performing functions as a server, but may be hardware installed inside or outside a terminal, and may be hardware in which software for performing a search service function is installed.

In this case, a computer program providing a search service according to some example embodiments may be stored in a memory 220 or a program storage unit 240 of the user terminal 200 such that the user terminal 200 itself operates as the search service providing device 100. In detail, an input receiver 110 of the search service providing device 100 may be included in an input/output (I/O) unit 230 of the user terminal 200 or receive an input of the user, which is detected by the I/O unit 230. Also, a communication unit 210, the memory 220, the program storage unit 240, and a controller of the user terminal 200 may respectively perform functions of a communication unit 130, a memory 140, a program storage unit 150, and a controller 120 of the search service providing device 100.

Alternatively, the search service providing device 100 may operate as a device that provides only functions of determining the additional search words from the initial search word and displaying the additional search results. A general search function and functions of a search server that stores search data may be performed by a portal service providing server 400. In other words, when the initial search word is input to the user terminal 200, the user terminal 200 may request the portal service providing server 400 to provide the initial search result corresponding to the initial search word. Here, the user terminal 200 in which a search service program according to some example embodiments is installed may determine the additional search words from the initial search word, determine the rankings of the additional search words, and request the portal service providing server 400 to provide the additional search results corresponding to all or some of the additional search words based on the determined rankings.

As described above, the search service providing device 100 may be a device included in a server that provides a search service or may be a device included in the user terminal 200. Hereinafter, a case in which the search service providing device 100 is included in a server that provides a search service will be mainly described.

FIG. 3 is a schematic block diagram of an internal structure of the search service providing system of FIG. 1.

Referring to FIG. 3, the search service providing system 10 according to some example embodiments may include the search service providing device 100, the user terminal 200, and the communication network 300. The search service providing device 100 may include the input receiver 110 and the controller 120. Also, the search service providing device 100 may further include the communication unit 130, the memory 140, the program storage unit 150, and a database (DB) 160.

The input receiver 110 may receive the initial search word from the user. In other words, the search service providing device 100 may receive the initial search word transmitted from the user terminal 200 to the input receiver 110.

Here, the input receiver 110 may receive data from the user terminal 200 through the communication network 300. In other words, the input receiver 110 may be a component of the communication unit 130 that exchanges data with the user terminal 200.

The controller 120 may generally control overall operations of the search service providing device 100. For example, the controller 120 may execute programs stored in the program storage unit 150 to generally control the input receiver 110, the communication unit 130, the memory 140, the program storage unit 150, the DB 160, and other components included in the search service providing device 100.

The controller 120 may include any type of device capable of processing data, such as a processor. Here, the ‘processor’ may denote, for example, a data processing apparatus embedded in hardware and having a physically structured circuit to perform a function expressed in a code or command included in a program. Examples of the data processing apparatus embedded in hardware may include a microprocessor, a central processing unit (CPU), a processor core, a multiprocessor, an application specific integrated circuit (ASIC), and a field programmable gate array (FPGA), but are not limited thereto.

The controller 120 may provide the initial search result corresponding to the received initial search word to the user terminal 200.

The controller 120 may determine the one or more additional search words based on the received initial search word, and provide the determined additional search words to the user terminal 200. For example, when the initial search word is ‘cough’, the controller 120 may determine, as the additional search words, names of various types of diseases that may cause coughing. As another example, when the initial search word is ‘lease’, the controller 120 may determine, as the additional search words, differences between the terms lease, purchase and monthly rent, and creation of right on lease, moving-in notification, and obtaining of a definite date, which may be executed after lease.

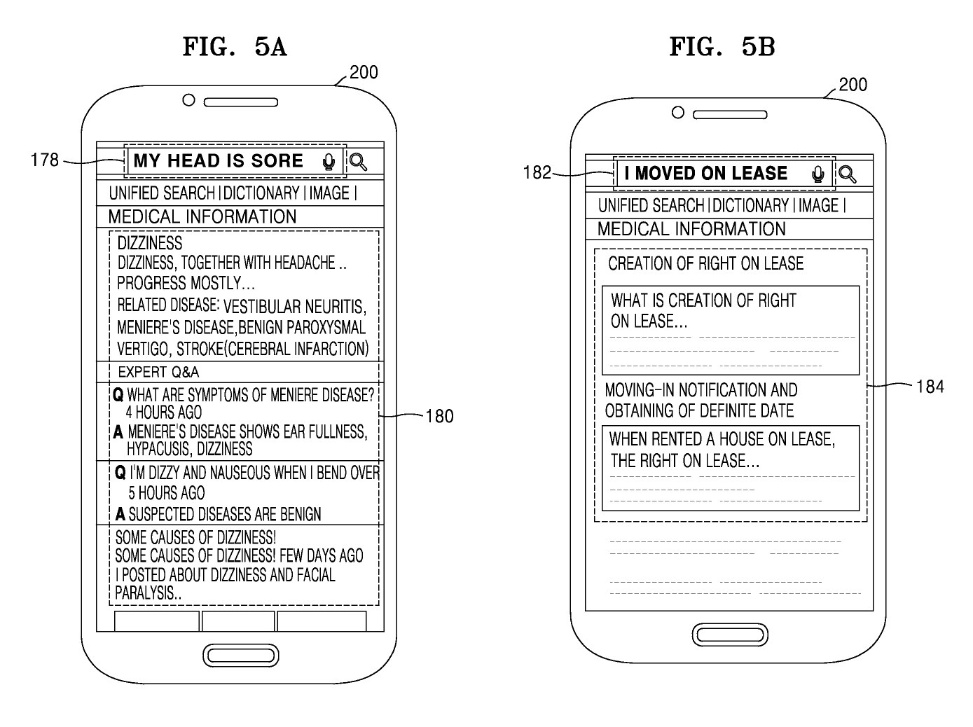

Then, the controller 120 may determine the rankings of the determined additional search words. Various elements may be considered while determining the rankings of the additional search words, and details thereof will be described below with reference to FIGS. 4 and 5.

Then, the controller 120 may provide the additional search results corresponding to one or more additional search words having high rankings to the user terminal 200, in consideration of the rankings of the additional search words.

At this time, the controller 120 may include an additional search word determiner 121, a ranking determiner 122, and a search result provider 123. In this case, the additional search word determiner 121 may determine the one or more additional search words based on the received initial search word. Also, the ranking determiner 122 may determine the rankings of the determined additional search words. Also, the search result provider 123 may provide the initial search result and the additional search results to the user terminal 200.

The communication unit 130 may exchange a wired/wireless signal with the user terminal 200, the portal service providing server 400, or a base station on the communication network 300. The communication unit 130 may be a Bluetooth communication unit, a Bluetooth low energy (BLE) communication unit, a near field communication unit, a wireless local area network (WLAN) (Wi-Fi) communication unit, a Zigbee communication unit, an infrared data association (IrDA) communication unit, a Wi-Fi direct (WFD) communication unit, an ultra wideband (UWB) communication unit, or an Ant+ communication unit, but is not limited thereto.

The memory 140 may temporarily or permanently store data processed by the controller 120. Here, the memory 140 may include a magnetic storage medium or a flash storage medium, but the range of some example embodiments is not limited thereto.

The program storage unit 150 may include control software that performs operations of exchanging data with the user terminal 200 or the portal service providing server 400 and various necessary or auxiliary operations to perform such operations.

The DB 160 may store information, search words, inquiries, or responses corresponding to inquiries, which are received from the user terminal 200 that exchanges data.

Here, the DB 160 may include a search word DB 161 that stores search words or inquiries received from the user terminal 20 (and other users using the search service) that exchanges data. Also, the DB 160 may include a response DB 162 that stores responses to information or inquiries, the responses received from the user terminal 200 (and other users using the search service) that exchanges data.

Also, at least one of the DB 160, the search word DB 161, and the response DB 162 may change a part of speech, such as a verb or an adjective, to a noun or change a part of speech to a basic form or singular form while storing the received search words, inquiries, or responses corresponding to inquiries. For example, when words received from the user terminal 200 are ‘I'm dizzy’, at least one of the DB 160, the search word DB 161, and the response DB 162 may store an adjective corresponding to ‘I'm dizzy’ by changing it to the basic adjective ‘dizzy’ or may store a noun by changing a part of speech to a noun, such as ‘dizziness’.

Also, the DB 160 may include a user DB storing information about the user of the user terminal 200 that exchanges data. Here, the information about the user may include an age, a gender, an occupation, an address, an area of self-input interest, an area of previously input information, an area of previously input search words, an area of previously input inquiries, and an area of previously input responses.

Continuously referring to FIG. 3, the user terminal 200 according to some example embodiments may include the communication unit 210, the memory 220, the I/O unit 230, the program storage unit 240, and the controller 250.

The communication unit 210 may be a device including hardware or software used to exchange data with at least one of the search service providing device 100, the portal service providing server 400, and the base station through the communication network 300 via wired/wireless connection.

The memory 220 may temporarily or permanently store data processed by the controller 250. Here, the memory 220 may include a magnetic storage medium or a flash storage medium, but the range of some example embodiments is not limited thereto.

The I/O unit 230 may include a display unit and an input unit. The display unit may be a device displaying an interface used for the user of the user terminal 200 to write or read information, search words, inquiries, or responses corresponding to inquiries. The display unit may include at least one of a liquid crystal display (LCD), a thin-film transistor-liquid crystal display (TFT-LCD), an organic light-emitting diode (OLED), a flexible display, a 3-dimensional (3D) display, and an electrophoretic display, but the range of some example embodiments are not limited thereto. The input unit may be a unit for receiving a command from the user of the user terminal 200 to control the user terminal 200. Examples of the input unit may include a keyboard, a keypad, a dome switch, a touch pad (a touch capacitance type, a pressure resistance film type, an infrared light detecting type, a surface ultrasound conducting type, an integral tension measuring type, or a piezo-effect type), a jog wheel, and a jog switch, and a mouse, but are not limited thereto. The input unit may be a device performing a click input through a mouse of the user, an input through a keyboard of the user, or a voice input of the user, a device receiving such inputs, or a device detecting such inputs, but is not limited thereto.

The program storage unit 240 may include control software that performs operations of exchanging data with the search service providing device 100 or the portal service providing server 400 and various necessary or auxiliary operations to perform such operations.

The controller 250 may generally control overall operations of the user terminal 200. For example, the controller 250 may execute programs stored in the program storage unit 240 to generally control the communication unit 210, the memory 220, the I/O unit 230, the program storage unit 240, and other components included in the user terminal 200. The controller 250 may include any type of device capable of processing data, such as a processor. Examples of the controller 250 may include a microprocessor, a CPU, a processor core, a multiprocessor, ASIC, and FPGA, but are not limited thereto.

FIGS. 4 and 5 are schematic diagrams of examples of search data being provided by a search service providing device, according to some example embodiments.

Referring to FIG. 4, the search service providing device 100 according to some example embodiments may provide to the user terminal 200 an initial search result corresponding to an initial search word received from the user terminal 200. In addition, the search service providing device 100 may provide additional search words determined based on the initial search word, and additional search results corresponding to at least one of the additional search words to the user terminal 200.

The search service providing device 100 may provide the initial search result related to the initial search word to the user terminal 200. For example, as shown in FIG. 4, a first initial search word 170 of ‘dizziness’ may be received from the user terminal 200. In this case, the controller 120 of the search service providing device 100 may provide a search result corresponding to the first initial search word 170 of ‘dizziness’, e.g., a first initial search result 172, to the user terminal 200. The first initial search result 172 may include a definition of dizziness, causes of dizziness, or text including the word ‘dizziness’.

Here, the first initial search result 172 may be data selected from pieces of information or responses stored in the response DB 162. Accordingly, the search service providing device 100 may use data received previously from the user terminal 200 to provide a response with respect to a search word currently received from the user terminal 200.

The search service providing device 100 may determine one or more additional search words based on the received initial search word. For example, as shown in FIG. 4, the controller 120 of the search service providing device 100 may determine, in relation to the initial search word of ‘dizziness’, first additional search words 174 of ‘Meniere's disease’, ‘vestibular neuritis’, ‘benign paroxysmal vertigo’ and ‘stroke’, which may cause dizziness.

Here, the first additional search words 174 may be data selected from search words or inquiries stored in the search word DB 161. Also, the first additional search words 174 may be data stored in the search word DB 161 in relation to the first initial search word 170. Here, the data stored in relation to the first initial search word 170 may be search words or inquiries searched for before or after searching the first initial search word 170 in previous searches, because it is likely that content searched for before or after searching the first initial search word 170 relate to a phenomenon or incident that may be a cause of, a result of, or occur together with the first initial search word 170. Accordingly, the search service providing device 100 may determine the first additional search words 174 related to the first initial search word 170.

Also, while selecting additional search words from search words or inquiries stored in the search word DB 161, the search service providing device 100 may consider information about a user who input the search words or inquiries. For example, in relation to ‘dizziness’, a person who has medical expertise, such as a doctor or a pharmacist, may have input a search word of ‘Meniere's disease’, and an ordinary person who is not knowledgeable about medical science may have input a search word of ‘cold’. In this case, the controller 120 of the search service providing device 100 may determine the search word input by the expert as an additional search word prior to the search word input by the ordinary person. Such information about a user may be stored in a user DB included in the DB 160.

The search service providing device 100 may determine rankings of the determined additional search words.

Here, the controller 120 of the search service providing device 100 may determine the rankings of the search words in order of the highest number of responses corresponding to each of the additional search words included in the response DB 162. For example, when ‘Meniere's disease’, ‘ vestibular neuritis’, ‘benign paroxysmal vertigo’, and ‘stroke’ are selected as the first additional search words 174, and the number of responses related to ‘Meniere's disease’ is greater than the number of responses related to other additional search words, ‘Meniere's disease’ may be determined to be ranked no. 1.

Alternatively, the controller 120 of the search service providing device 100 may determine the rankings of the additional search word in order of the highest number of responses given by an expert in an area related to the responses from among the responses corresponding to each of the additional search words included in the response DB 162.

Alternatively, the controller 120 of the search service providing device 100 may use statistical data stored in the DB 160 or the like to check information about the number of occurrences corresponding to each of the additional search words within a certain period of time, the number of times an occurrence corresponding to the initial search word and an occurrence corresponding to each of the additional search words occur contemporaneously within a certain period of time, and a probability that an occurrence corresponding to each of the additional search words also occurs when an occurrence corresponding to the initial search word occurs. Then, the controller 120 of the search service providing device 100 may determine the additional search words that have statistically high occurrence probabilities or have high occurrences of high rankings.

Also, the controller 120 of the search service providing device 100 may check information about an age, a gender, an occupation, an address, an area of self-input interest, an area of previously input information, an area of previously input search words, an area of previously input inquiries, and an area of previously input responses, which are input by a search service user who input the initial search word. Then, the controller 120 of the search service providing device 100 may determine the rankings of the additional search words in order of highest number of times each of the additional search words was searched for by other users having the same or similar personal data as the search service user.

Alternatively, the controller 120 of the search service providing device 100 may consider the number of times each of the additional search words was searched for by users who used the search service providing device 100 within a certain period of time, or an average reading time of additional search results corresponding to each of the additional search words. Then, the controller 120 of the search service providing device 100 may determine the rankings of the additional search words in order of highest number of times each of the additional search words was searched for or in order of longest average reading time of the additional search results corresponding to each of the additional search words.

As described above, when the number of responses corresponding to each of the additional search words, the probability that each of the additional search words may occur, information about the user who input the initial search word, or satisfaction of past users is considered while determining the rankings of the additional search words, the additional search words having high probabilities of actually occurring or having high importance may be ranked high. Accordingly, the search service providing device 100 may provide the ranked additional search word having high probability of helping the user of the search service.

The search service providing device 100 may select at least one additional search word in order of highest rankings from among the entire additional search words. Then, the search service providing device 100 may provide additional search results corresponding to the selected additional search words to the user terminal 200. For example, as shown in FIG. 4, ‘Meniere's disease’, ‘vestibular neuritis’, ‘benign paroxysmal vertigo’, and ‘stroke’ may be selected as the first additional search words 174, and ‘Meniere's disease’ may be determined to have a highest ranking. In this case, the controller 120 of the search service providing device 100 may provide only a first additional search result 176 regarding ‘Meniere's disease’ to the user terminal 200 together with the first initial search result 172 and the first additional search words 174.

Here, the first additional search result 176 may be data selected from the pieces of information or responses stored in the response DB 162. Accordingly, the search service providing device 100 may use data received previously from the user terminal 200 to provide a response to an additional search word to the user terminal 200.

The search service providing device 100 may receive feedback on the provided additional search words and the additional search results from the user terminal 200. In other words, the input receiver 110 of the search service providing device 100 may receive, from the user terminal 200, an evaluation, such as in terms of accuracy or satisfaction, with respect to the additional search words and the additional search results, as evaluation factors of how appropriate the additional search words and the additional search results were to the user of the search service. Then, the controller 120 of the search service providing device 100 may later use the received evaluation, such as in terms of the accuracy or the satisfaction, to select the additional search words or determine the rankings of the additional search words in future searches.

Referring to FIG. 5, when a search word in natural language form is received from the user terminal 200, the search service providing device 100 may determine an initial search word via a method of determining a certain noun from the natural language. In detail, the input receiver 110 of the search service providing device 100 may receive a natural search word including a noun, a pronoun, a numeral, a verb, an adjective, a determiner, an adverb, a postposition or an interjection. Here, the controller 120 of the search service providing device 100 may select a word included in the natural search word or may determine the initial search word via a method of determining a noun from parts of speech of the natural search word.

For example, as shown in FIG. 5 (a), a first natural search word 178 of ‘My head is sore’ from the user terminal 200. In this case, the controller 120 of the search service providing device 100 may determine that the ‘head’ is in a certain state due to the noun ‘head’ and the verb ‘is’. Also, the controller 120 of the search service providing device 100 may analyze the natural language ‘My head is sore’ and determine that the phrase has a meaning that the ‘head’ is in a state of ‘sore’ due to the noun ‘head’ and the verb ‘is’, thereby determining an initial search word ‘dizziness’. Also, as described above, the search service providing device 100 may determine additional search words, such as ‘Meniere's disease; and ‘stroke’, from ‘dizziness’ and additional search results 180 corresponding to the additional search words, and provide the additional search words and the additional search results 180 to the user terminal 200.

As another example, as shown in FIG. 5 (b), second natural search words 182 of ‘I moved to a leased house’ may be received from the user terminal 200. In this case, the controller 120 of the search service providing device 100 may analyze the natural language to determine initial search words, such as ‘creation of right on lease’ and ‘moving-in notification and obtaining of a definite date’, and search results 184 corresponding thereto, and provide the initial search words and the search results 184 to the user terminal 200.

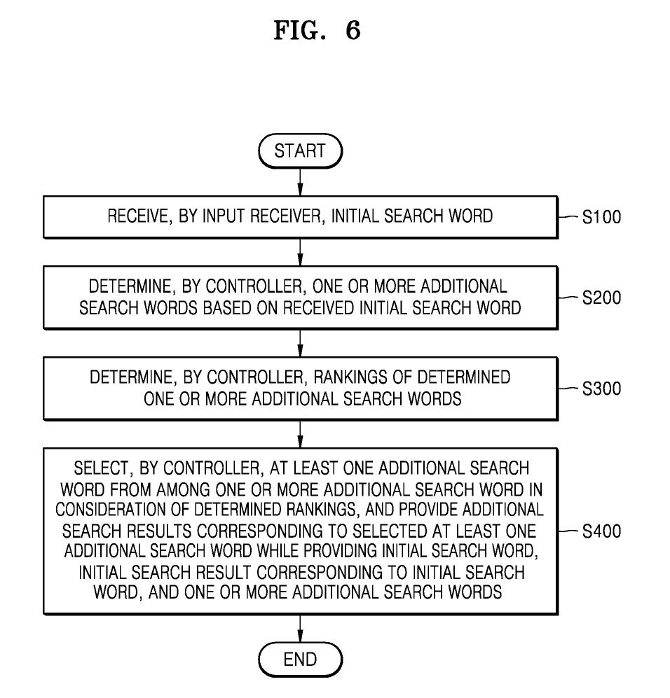

FIG. 6 is a flowchart of a search service providing method according to some example embodiments.

The flowchart of FIG. 6 includes operations performed in time series by the search service providing device 100 of FIGS. 1 through 5. Accordingly, details described with reference to the components of FIGS. 1 through 5 may also be applied to the flowchart of FIG. 6 even if omitted below.

Referring to FIG. 6, the search service providing method according to some example embodiments may include receiving, by an input receiver, an initial search word (operation S100), determining, by a controller, one or more additional search words based on the received initial search word (operation S200), determining, by the controller, rankings of the determined one or more additional search words (operation S300), and selecting, by the controller, at least one additional search word from among the one or more additional search words in consideration of the determined rankings and displaying additional search results corresponding to the selected at least one additional search word while displaying the initial search word, an initial search result corresponding to the initial search word, and the one or more additional search words (operation S400).

By using the search service providing device 100 and the search service providing method according to some example embodiments, one or more additional search words may be determined from an initial search word received from a user, and additional search results regarding the additional search words may be provided together with an initial search result regarding the initial search word. Accordingly, the search service providing device 100 and the search service providing method according to some example embodiments may provide all information desired by the user without the user having to repeat several searches, and provide useful information even when the user does not know a technical term or procedures of a certain area.

In addition, by using the search service providing device 100 and the search service providing method according to some example embodiments, rankings of additional search words may be determined and additional search results for only some of the additional search words may be provided in consideration of the determined rankings. Accordingly, a user may be prevented from being confused by provision of additional search results related to something that is probabilistically unlikely to occur or to content that may not be largely related.

One or more of the above example embodiments may be embodied in the form of a computer program that may be run in a computer through various elements. The computer program may be recorded on a non-transitory computer-readable recording medium. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Furthermore, the non-transitory computer-readable recording medium may be a formless medium that may be transmitted and distributed in a network, e.g., software or an application.

Meanwhile, the computer programs may be specially designed or well known to one of ordinary skill in the computer software field. Examples of the computer programs include mechanical code prepared by a compiler, and high-level languages executable by a computer by using an interpreter.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device. Moreover, no item or component is essential to the practice of the example embodiments unless the element is specifically described as “essential” or “critical”.

It should be understood that example embodiments described herein should be considered in a descriptive sense only and not for purposes of limitation. Descriptions of features or aspects within some example embodiments should typically be considered as available for other similar features or aspects in other example embodiments.

Some example embodiments may be used for a search service providing device, method and a non-transitory computer readable medium storing a computer program increasing convenience of a user using a search function by determining one or more additional search words from an initial search word received from the user and providing additional search results for the additional search words together with an initial search result for the initial search word.

1. A search service providing method of providing search results related to a search word performed by a search service providing device, the search service providing method comprising:
receiving, by the search service providing device, an initial search word;
determining, by the search service providing device, one or more additional search words based on the initial search word;
ranking, by the search service providing device, the one or more additional search words;
selecting, by the search service providing device, at least one related search word from among the one or more additional search words based on the ranking; and
providing, by the search service providing device,
additional search results corresponding to the at least one related search word,
the initial search word,
an initial search result corresponding to the initial search word, and
the one or more additional search words.

2. The search service providing method of claim 1, wherein the receiving comprises:
receiving, by the search service providing device, natural language search words including one or more parts of speech from among a noun, a pronoun, a numeral, a verb, an adjective, a determiner, an adverb, a postposition, and an interjection; and
determining, by the search service providing device, the initial search word by selecting at least one noun from the natural language search words or determining a word corresponding to all or some of the one or more parts of speech.

3. The search service providing method of claim 1, further comprising at least one of:
generating, by the search service providing device, a search word database that stores search words or inquiries received from a plurality of users using the search service, or
updating the search word database that is pre-generated; and
generating, by the search service providing device, a response database that stores responses to information or inquiries, the responses received from a plurality of users using the search service, or
updating the response database that is pre-generated.

4. The search service providing method of claim 3, wherein the determining the one or more additional search words includes determining one or more additional search words related to the initial search word from words existing in the search word database.

5. The search service providing method of claim 3, wherein the ranking includes ranking the one or more additional search words in order of highest number of responses corresponding to each of the one or more additional search words included in the response database.

6. The search service providing method of claim 3, wherein the generating or the updating of the search word database includes storing information indicating whether the plurality of users who input the search words are each an expert in an area related to the search words; and
the determining of the one or more additional search words includes determining one or more additional search words related to the initial search word from search words prepared by an expert in an area related to the initial search word.

7. The search service providing method of claim 3, wherein the generating or the updating of the response database includes storing information indicating whether the plurality of users who input the responses are each an expert in an area related to the responses; and
the ranking includes ranking the one or more additional search words in order of highest number of responses prepared by an expert in an area related to the responses, the responses corresponding to each of the one or more additional search words included in the response database.

8. The search service providing method of claim 3, wherein the providing the additional search results includes providing responses corresponding to the at least one related search word from the response database.

9. The search service providing method of claim 1, wherein the selecting the at least one related search word includes selecting at least one of the one or more additional search words ranked higher than at least one of other of the one or more additional search words based on the ranking.

10. The search service providing method of claim 1, wherein the ranking includes ranking the one or more additional search words in consideration of at least one of
a number of occurrences corresponding to each of the one or more additional search words in a database within a certain period of time,
a number times an occurrence corresponding to the initial search word and an occurrence corresponding to each of the one or more additional search words occur contemporaneously in the database within a certain period of time, and
a probability that an occurrence corresponding to each of the one or more additional search words also occurs in the database when an occurrence corresponding to the initial search word occurs the database.

11. The search service providing method of claim 1, wherein the ranking include ranking the one or more additional search words in consideration of at least one of an age, a gender, an occupation, an address, an area of self-input interest, an area of previously input information, an area of previously input search words, an area of previously input inquiries, and an area of previously input responses, which are input by a search service user who input the initial search word.

12. The search service providing method of claim 1, wherein the ranking includes ranking the one or more additional search words in consideration of at least one of
a number of times a plurality of users who used the search service has searched each of the one or more additional search words within a certain period of time, and
an average reading time of the additional search results corresponding to each of the one or more additional search words.

13. The search service providing method of claim 1, further comprising:
receiving, after the providing the additional search results, by the search service providing device, at least one of an accuracy indication and a satisfaction indication regarding all or some of the one or more additional search words and the additional search results from a search service user.

14. The search service providing method of claim 13, wherein the ranking includes ranking the one or more additional search words in order of highest accuracy or satisfaction based on the accuracy indication or the satisfaction indication, respectively.

15. A computer program stored in a non-transitory computer-readable medium which, when executed by a controller, performs the search service providing method of claim 1.

16. A search service providing device for providing search results related to a search word, the search service providing device comprising:
an input receiver configured to receive an initial search word; and
a controller configured to
determine one or more additional search words based on the initial search word,
determine rankings of the one or more additional search words,
select at least one related search word from among the one or more additional search words based on the rankings, and
provide
additional search results corresponding to the at least one related search word,
the initial search word,
an initial search result corresponding to the initial search word, and
the one or more additional search words.

17. The search service providing device of claim 16, wherein the controller is further configured to at least one of:
generate a search word database that stores search words or inquiries received from a plurality of users using the search service, or
update the search word database that is pre-generated; and
generate a response database that stores responses to information or inquiries, the responses received from a plurality of users using the search service, or
update the response database that is pre-generated.

18. The search service providing device of claim 16, wherein the controller is configured to determine the rankings in consideration of at least one of
a number of occurrences corresponding to each of the additional search words in a database within a certain period of time,
a number times an occurrence corresponding to the initial search word and an occurrence corresponding to each of the additional search words occur contemporaneously in the database within a certain period of time, and
a probability that an occurrence corresponding to each of the additional search words also occurs in the database when an occurrence corresponding to the initial search word occurs in the database.

19. The search service providing device of claim 16, wherein the input receiver is further configured to receive at least one of an accuracy indication and a satisfaction indication regarding all or some of the one or more additional search words and the additional search results from a search service user, and
the controller is configured to determine the rankings of the one or more additional search words in order of highest accuracy or satisfaction based on the accuracy indication or the satisfaction indication, respectively.

20. The search service providing device of claim 16, wherein the controller comprises:
an additional search word determiner configured to determine the one or more additional search words based on the initial search word;
a ranking determiner configured to determine the rankings of the one or more additional search words; and
a search result provider configured to
select the at least one related search word from among the one or more additional search words in consideration of the rankings, and
provide
the additional search results corresponding to the at least one related search word,
the initial search word,
the initial search result corresponding to the initial search word, and
the one or more additional search words.
